(19) United States
(12) Patent Application Publication
(10) Pub. No.: US 2020/0236876 A1
(43) Pub. Date: Jul. 30, 2020

(54) LASER-BASED AGRICULTURE SYSTEM

(71) Applicant: KING ABDULLAH UNIVERSITY OF SCIENCE AND TECHNOLOGY, Thuwal (SA)

(72) Inventors: Boon OOI, Thuwal (SA); Aloysius WONG, Thuwal (SA); Tien Khee NG, Thuwal (SA)

(21) Appl. No.: 16/846,613

(22) Filed: Apr. 13, 2020

Related U.S. Application Data
(63) Continuation of application No. 14/868,422, filed on Sep. 29, 2015.
(60) Provisional application No. 62/056,853, filed on Sep. 29, 2014.

(51) Int. Cl. A01G 22/00; A01G 7/04; A01G 9/00

(52) U.S. Cl. CPC A01G 22/00; Y02P 60/146; A01G 9/00; A01G 7/045

(57) ABSTRACT

A system and method are provided for indoor agriculture using at least one growth chamber illuminated by laser light. In an example embodiment of the agriculture system, a growth chamber is provided having one or more walls defining an interior portion of the growth chamber. The agriculture system may include a removable tray disposed within the interior portion of the growth chamber. The agriculture system also includes a light source, which may be disposed outside the growth chamber. The one or more walls may include at least one aperture. The light source is configured to illuminate at least a part of the interior portion of the growth chamber. In embodiments in which the light source is disposed outside the growth chamber, the light source is configured to transmit the laser light to the interior portion of the growth chamber via the at least one aperture.

### CROSS-REFERENCE TO RELATED APPLICATIONS

This application is a continuation of U.S. patent application Ser. No. 14/868,422, filed Sep. 25, 2015, which claims priority and benefit of U.S. Provisional Patent Application No. 62/056,853, filed Sep. 29, 2014, the entire contents of which are incorporated by reference herein.

### TECHNOLOGICAL FIELD

Example embodiments of the present invention relate generally to indoor agriculture and, more particularly, to a system for growing plants using light amplification by stimulated emission of radiation (i.e., laser).

### BACKGROUND

Food security is a pressing issue in many regions of the world, due in large part to climates that are inhospitable for plant growth. In this regard, plant cultivation relies heavily on two important resources: water and light. The former is a scarce commodity in many regions (such as, for example, in the Kingdom of Saudi Arabia, where less than 2% of the country's land is considered arable). The limited supply of clean water means that its management and consumption efficiency are of paramount importance. Because more than 95% water is lost through evaporation in open field farming, one option is to cultivate plants in an enclosed environment. This not only reduces the rate of water evaporation, but also enables evaporated moisture to be contained and recycled for future plant consumption. As a result, indoor plant cultivation consumes roughly 10% of the water required for open field farming.

The latter resource, light, also plays a role in plant cultivation. Many regions have inhospitable amounts and intensities of natural sunlight (e.g., photoperiods, light quantities, or light qualities that are not conducive to plant growth). As a result, in many regions, even indoor plant cultivation is not practical unless the light source can be regulated in some fashion. One mechanism for regulating light employs artificial light in place of natural sunlight. To this end, indoor plant growth chambers have used a number of types of artificial light sources, such as incandescent light bulbs, gas discharge lamps (e.g., fluorescent lamps), high-intensity discharge lamps (e.g., high-intensity sodium discharge lamps), or electroluminescent lamps (e.g., light emitting diode ((LED) lamps).

### BRIEF SUMMARY

The inventors have discovered several inefficiencies of using these artificial light sources in indoor agriculture. First, these artificial light sources must be located within plant growth chambers; however, generating light also generates heat, which can be harmful to plant life. Placing an artificial light source within a growth chamber increases the energy required to maintain an appropriate temperature. Moreover, perfect temperature regulation is often not practically possible, so some amount of damage to plants may be unavoidable when artificial light sources are placed in close proximity to plants. Second, indoor vertical agriculture (which employs multiple tiers of plants within a growth chamber) using artificial light sources traditionally requires a separate light source for every tier of plants. The use of multiple light sources within a growth chamber exacerbates the heating problem, and also adds another expense associated with development of an indoor agriculture system. Third, because plants can grow effectively under one or more narrow spectra of light, producing wavelengths of light that do not assist plant growth is, in effect, wasting energy. Fourth, these artificial light sources have varying degrees of “wall-plug efficiency” (e.g., the efficiency with which a system converts electrical power into optical power) that the inventors have determined to be sub-optimal.

As discussed in greater detail below, embodiments of the present invention illustrate an indoor agriculture system that advantageously addresses many problems encountered by traditional indoor agriculture systems, such as those noted above. Embodiments disclosed herein illustrate a laser-based agriculture device employing an external laser light source to generate high energy, highly efficient artificial light for growing plants in an indoor environment. Because of the coherence of laser light, locating a laser light source outside and apart from a plant growth chamber addresses the heat problem of traditional systems. In addition, because of the high intensity of laser light, a single beam of laser light can be split to illuminate multiple tiers of plants in a vertical agriculture arrangement. Thus, the user of a laser light source eliminates the necessity to provide a new light source for each tier of plants. Furthermore, laser light sources can produce light having a very narrow spectrum, thus avoiding the wasted generation of wavelengths that are unnecessary for plant growth. Moreover, the wall-plug efficiencies of laser light sources are in many instances higher than any of the artificial light sources discussed above. Thus, using a laser light source can further reduce the energy expense of the system.

In a first example embodiment, an agriculture system is provided. The agriculture system includes a growth chamber having one or more walls defining an interior portion. The agriculture system further includes a tray disposed within the interior portion of the growth chamber, wherein the tray is configured to support growth media and one or more agriculture products. The agriculture system further includes a light source configured to illuminate at least a part of the interior portion of the growth chamber with laser light.

In a second example embodiment, an agriculture system is provided that includes a growth chamber having one or more walls defining an interior portion. At least one of the one or more walls includes at least one aperture configured to communicate artificial light from outside the growth chamber into the interior portion of the growth chamber. The agriculture system of this example embodiment further includes an artificial light source disposed outside the growth chamber. Furthermore, the agriculture system of this example embodiment includes one or more optical elements configured to communicate artificial light from the artificial light source, via the at least one aperture, into the interior portion of the growth chamber.

In another example embodiment, a method is provided for growing agriculture products in a growth chamber having at least one aperture configured to communicate laser light from outside the growth chamber to an interior portion of the growth chamber. The method includes generating visible laser light by a laser light source disposed outside the growth chamber, and guiding the visible laser light through the at least one aperture to illuminate the interior portion of the growth chamber.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 shows a graph illustrating the relationship between wavelengths of light and the absorption of the light by pigments in the leaves and other parts of the plant;

FIG. 2 shows a schematic diagram of an example agriculture system, in accordance with example embodiments of the present invention;

FIG. 3A shows a schematic diagram illustrating aspects of another example agriculture system, in accordance with example embodiments of the present invention;

FIG. 3B shows a schematic diagram illustrating aspects of yet another example agriculture system, in accordance with example embodiments of the present invention;

FIG. 3C illustrates an example heating and cooling system that may be employed in accordance with example embodiments of the present invention;

FIG. 3D shows a schematic diagram of a growth chamber including an example water condensing tower, in accordance with example embodiments of the present invention;

FIG. 4A illustrates a schematic diagram of example optical elements for transmitting laser light, in accordance with example embodiments of the present invention;

FIG. 4B illustrates a block diagram of a laser light source and associated optical elements, in accordance with example embodiments of the present invention;

FIG. 5 illustrates a schematic diagram of a vertical agriculture arrangement, in accordance with example embodiments of the present invention;

FIG. 6 illustrates an example embodiment of a laser-based agriculture system, in accordance with example embodiments of the present invention;

FIG. 7 illustrates a schematic diagram illustrating elements of another agriculture system, in accordance with example embodiments of the present invention;

FIG. 8 illustrates a flowchart describing example operations for sterilizing a growth chamber and cultivating plants, in accordance with some example embodiments; and

FIG. 9 illustrates visual differences between plants grown under white fluorescent light, and plants grown under red and blue laser lights in accordance with an example embodiment described herein.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

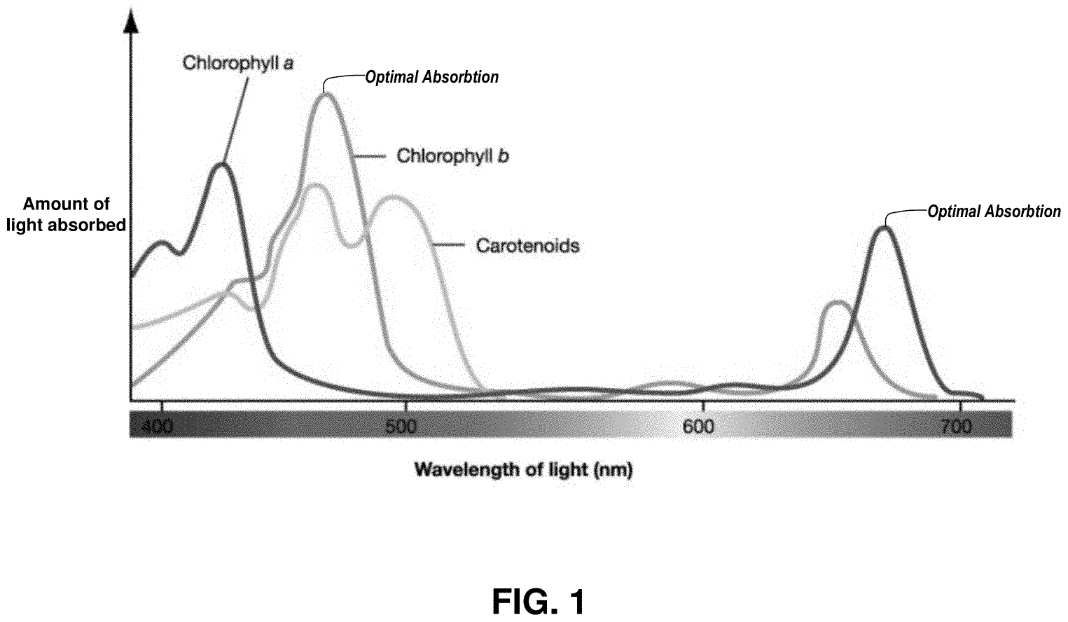

FIG. 1 provides a graph illustrating the relationship between wavelengths of light and the absorption of the light by pigments in the leaves and other parts of the plant. As shown, plants are most efficient absorbing light in two primary wavelengths: red and blue. However, as one might expect, different plant varieties demonstrate photosynthetic efficiency at different combinations of light wavelengths. Accordingly, different illumination formulae, each containing a combination of two or more wavelengths at suitable ratios and intensities, can be implemented to cultivate different types of plants, (for example, pigmented plants such as tomatoes are most efficient absorbing light under a different set of conditions than green plants such as cabbage and lettuce), and at different stages of plant growth and development (e.g., leaf development and flowering).

This fact demonstrates an additional benefit derived from utilizing a laser light source. As noted previously, using an externally-located laser light source reduces heat inside a growth chamber, enables illumination of multiple tiers of plants without adding additional light sources, avoids generation of unnecessary wavelengths of light, and can produce these improvements with more efficiency than traditional sources. In addition, however, the single-wavelength property of laser light generation enables embodiments disclosed herein to specifically tune the wavelengths, ratios, and intensities of the produced laser light to optimize plant growth based on the photosynthetic efficiency of the particular plant varieties placed in a growth chamber. In particular, unlike other light sources, the radiant energy of laser light can be finely tuned to match the absorption peaks of the photoreceptors (light sensing molecules) in plant leaves. Thus, unlike any other light source, laser light sources can maximize photosynthetic activity while eliminating the need for plants to “expend” energy reflecting unnecessary wavelengths of light.

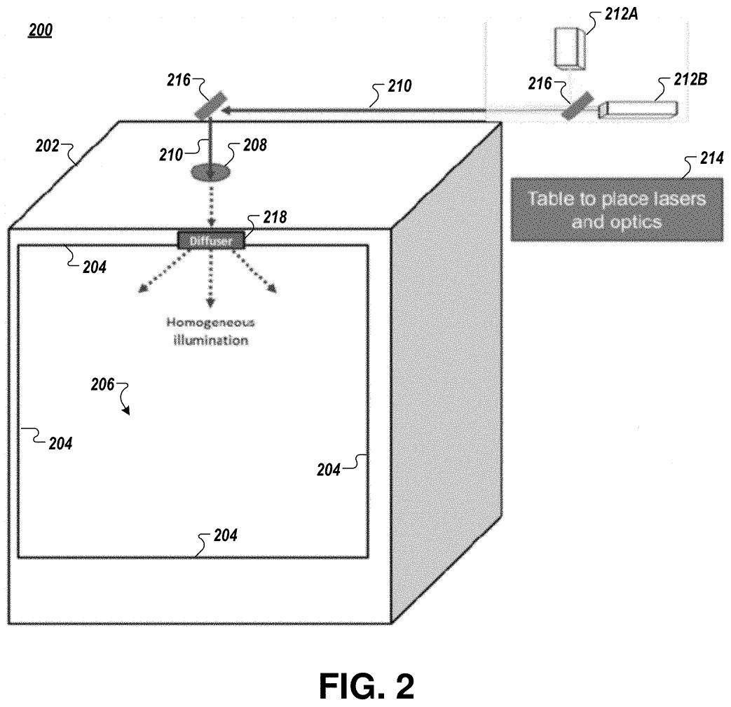

Example laser-based agriculture systems and devices that may be specifically configured for indoor plant growth are illustrated in FIGS. 2-6. It should be noted that while FIGS. 2-6 illustrates particular example configurations, hereinafter such elements should be considered capable of arrangement in many other configurations without departing from the spirit or scope of the invention.

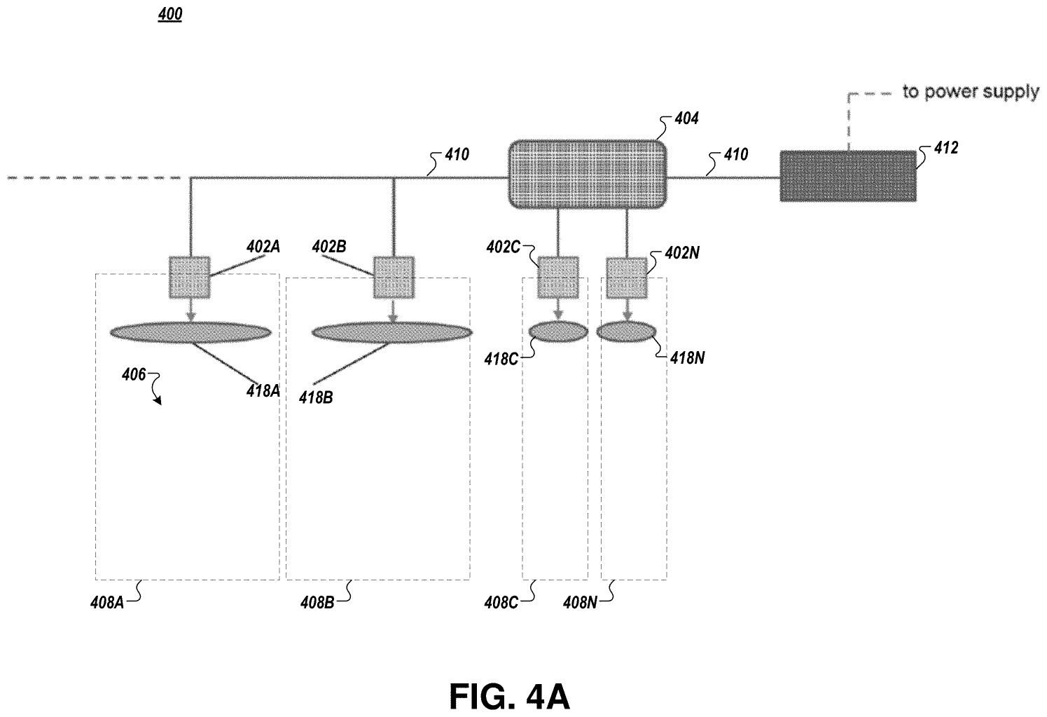

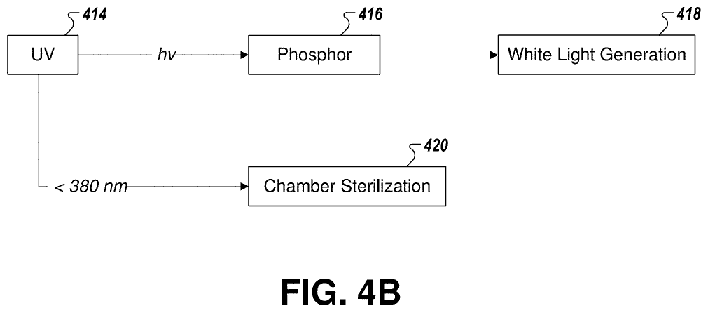

Turning now to FIG. 2, a schematic diagram of an example agriculture system is disclosed. Agriculture system 200 illustrates a growth chamber 202 having one or more walls 204 that define an interior portion 206. One or more of the walls 204 may contain an aperture 208 configured to communicate laser light 210 from outside the growth chamber 202 into the interior portion 206. This laser light 210 may be generated by one or more externally located laser light sources that in turn may be disposed on a table 214 or other supporting structure. Example embodiments of the one or more laser light sources are described in greater detail below in conjunction with FIG. 4A. It should be noted that while FIG. 2 illustrates a single aperture in a single wall, embodiments of the present invention may include multiple apertures in one or more of the walls of the growth chamber to communicate laser light 210 from a plurality of external laser light sources.

In the example shown in FIG. 2, two external laser light sources 212A and 212B are shown that generate distinct wavelengths of laser light. As discussed previously with regard to FIG. 1, it will be understood that a combination of narrow wavelengths of lights can stimulate plant growth. Accordingly, the example shown in FIG. 2 illustrates laser light sources 212A and 212B, which emit narrow wavelength laser lights at distinct wavelengths from each other. The laser light 210 emitted by laser light sources 212A and 212B may be passed through a diffuser 218 installed at the roof of the growth chamber 202, which scatters the incoming laser light 210 to provide a homogenous illumination of the interior portion 206 of the growth chamber 202, which in turn fosters plant growth. In this regard, the laser light 210 may in some embodiments be guided to the diffuser 218 using a series of dichroic mirrors 216 and other optical elements (described in greater detail in conjunction with FIG. 4A) such as diffusers (e.g., beam expanders) and/or collimators that are suspended by way of a cage assembly (or any other mechanism for fastening the optical elements in place).

It will be understood that while FIG. 2 illustrates laser light sources 212A and 212B that are external to the growth chamber 202, the laser light source(s) of other embodiments contemplated herein need not be disposed outside the growth chamber. Such embodiments do not need to include an aperture in any wall. Thus, in some such embodiments, the growth chamber may fully enclose the interior portion.

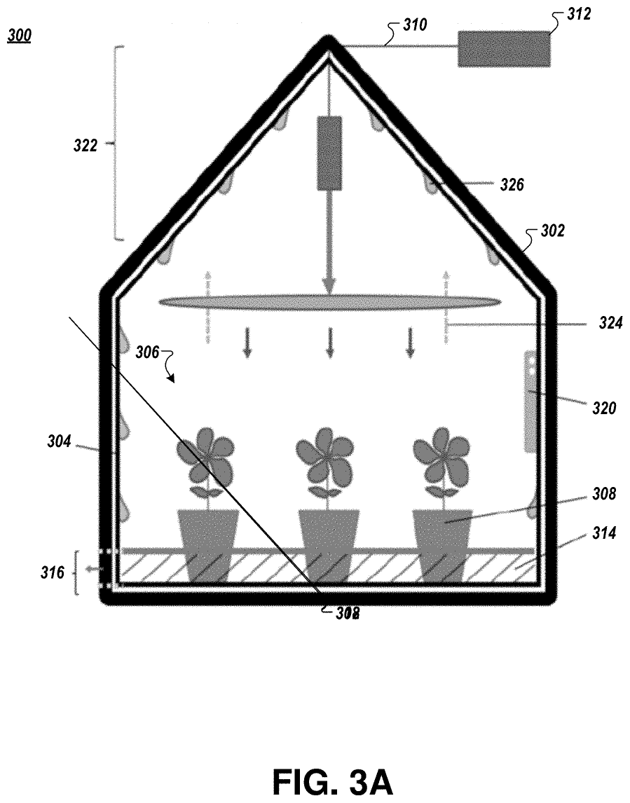

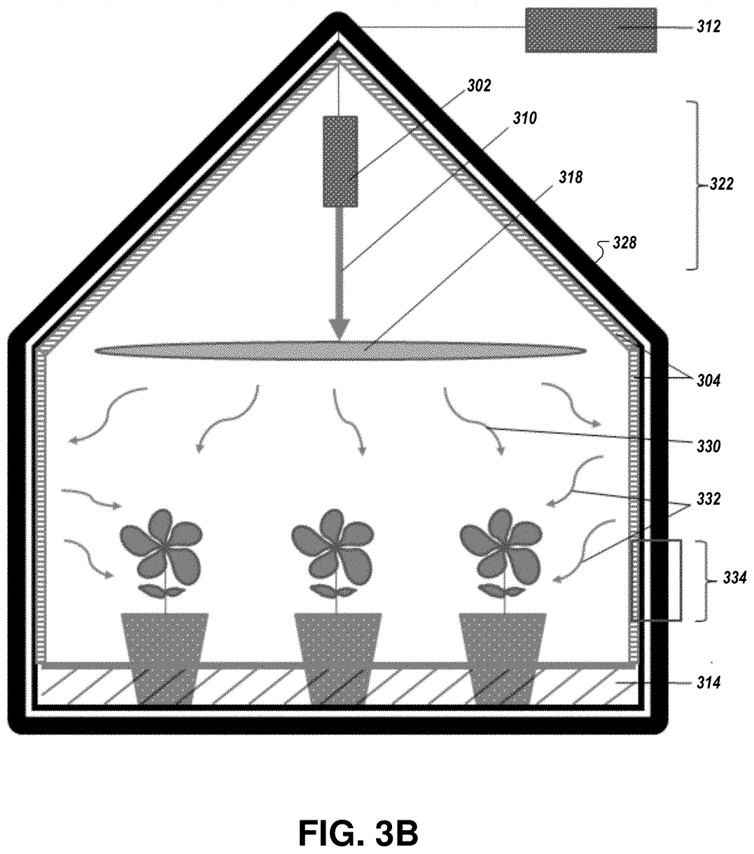

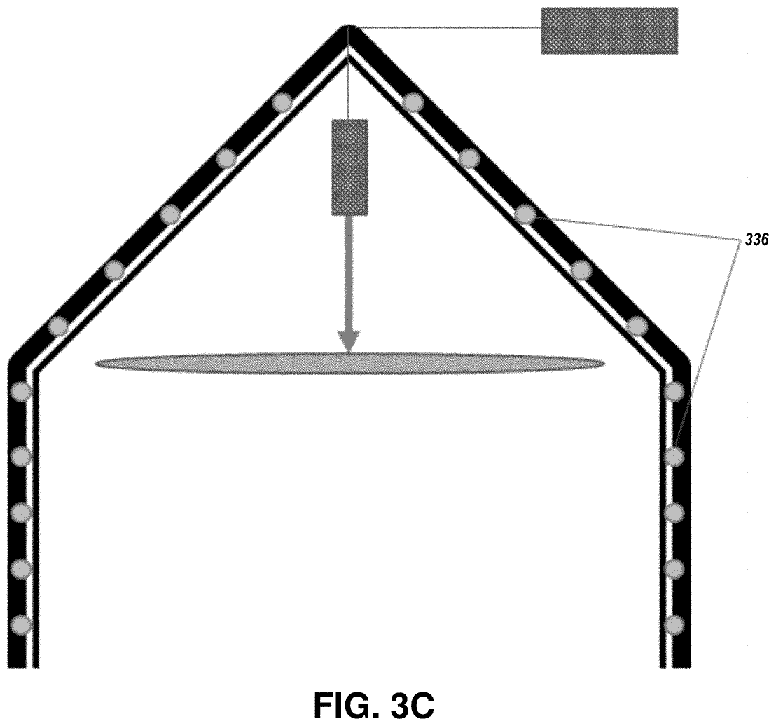

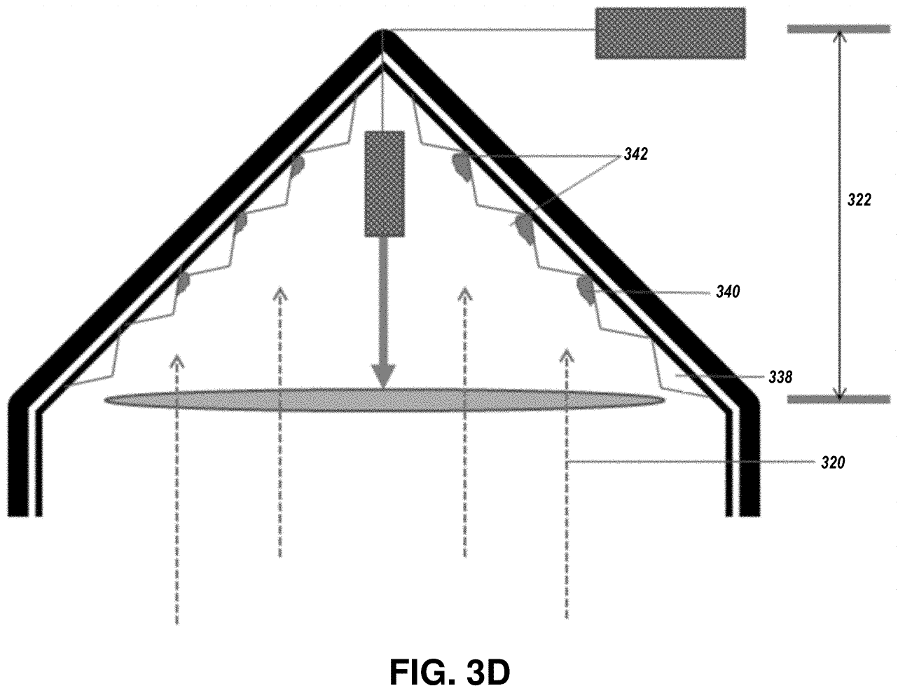

Turning now to FIG. 3A, a schematic diagram illustrates aspects of an example agriculture system that may be employed in conjunction with the example system described in FIG. 2. Agriculture system 300 includes one or more laser light source 312 and a diffuser 318, and also illustrates collimator 302, which narrows the laser light 310 entering the interior portion 306 of the growth chamber 302 and directs it into diffuser 318. Diffuser 318 subsequently scatters the laser light 310 to ensure the homogenous illumination of the interior portion 306 of the growth chamber 302. Collimating the laser light 310 prior to its entry into diffuser 318 provides greater uniformity of the light that leaves the diffuser 318 to illuminate the interior portion 306 of the growth chamber 302.

An inner wall lining 304 of at least one wall of the growth chamber 302 may comprise a reflective material to uniformly reflect and recycle photons back to plant tissues that would otherwise remain shaded, such as lower leaves, stems, and flower buds. This inner wall lining 304 may comprise at least one metallic or dielectric material having reflective properties. The inner wall lining 304 may specifically comprise at least one of SiO₂, Si₃N₄, aluminum, or chrome plating.

FIG. 3A further illustrates a number of plants 308 placed in a growth media 314 that in turn is disposed on a tray 316, all of which are located within the growth chamber 302. Tray 316 may in some embodiments be removable from the growth chamber 302, for example by a hatch (not shown) in one of the walls of the growth chamber 302, to enable the placement or removal of plants 308 or growth media 314. It should be noted that while plants are illustrated in several Figures, other agriculture products may be cultivated in accordance with embodiments of the present invention. For instance, embodiments described herein may be used for aquaculture, in which case laser light can be used to stimulate farming of fish, aquatic organisms, and/or aquatic plants disposed within liquid growth media in the growth chamber.

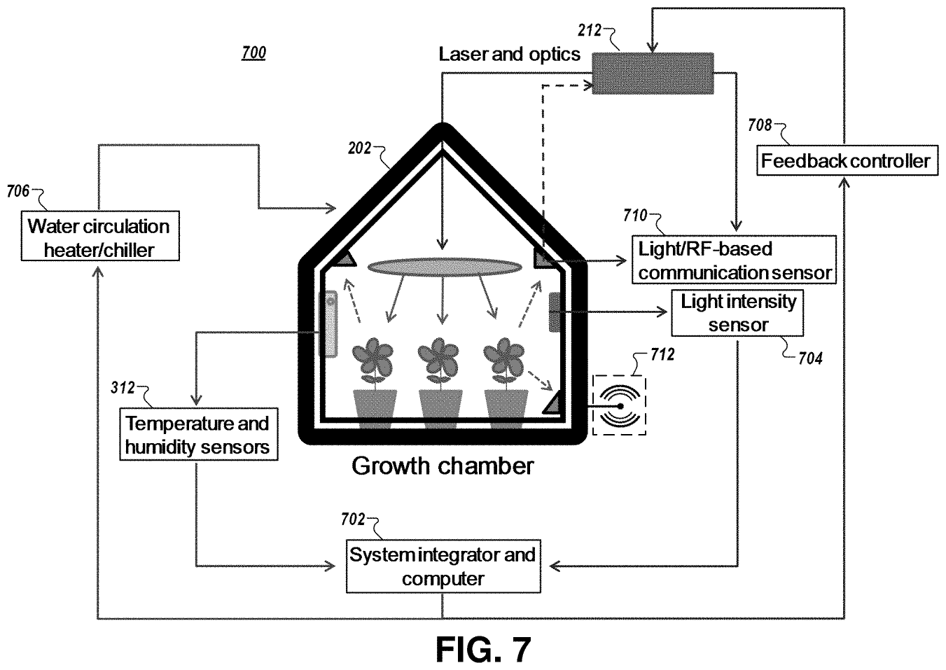

The growth chamber 302 may further include a heating and cooling system designed to regulate the temperature in the interior portion 306 of the growth chamber 302 (examples of which are illustrated in FIGS. 3B and 3D), and a humidifier designed to regulate the humidity within the interior portion 306 (not shown in FIG. 3A). Furthermore, the growth chamber 302 may include temperature and humidity sensors (shown together in FIG. 3A as element 320, although they may be located separately in some embodiments) for use in temperature and humidity regulation, and an alarm (not shown). The heating and cooling system and the humidifier will typically maintain optimal growing conditions within the interior portion 306 of the growth chamber. These conditions may be monitored by a system integrator/computer (e.g., computer 702 shown in FIG. 7) that controls operation of the heating and cooling system and the humidifier. In some embodiments, in response to the temperature sensor (e.g., a thermometer) measuring a temperature within the growth chamber 302 that falls outside a predetermined range, the system integrator/computer may modify operation of the heating and cooling system to react to the change in temperature. Additionally or alternatively, the temperature sensor may trigger the alarm, which may cause generation of a visual or auditory signal prompting a technician to attend to the issue. Similarly, in response to the humidity sensor measuring a relative humidity within the growth chamber 302 that falls outside a predetermined range, the system integrator/computer may modify operation of the humidifier to react to the change in humidify, and/or the humidity sensor may trigger the alarm to signal a technician.

FIG. 3A further illustrates a water condensation tower 322 at an upper region of the growth chamber 302, which will be described in greater detail in conjunction with FIG. 3C below.

It should be appreciated that although FIG. 3A illustrates the growth chamber 302 having a single tier of plants, in other embodiments contemplated by the present invention, the growth chamber 302 may include multiple tiers of plants (with concomitant growth media 314 and trays 316). While in some multi-tiered embodiments, there may be a single condensation tower 322 at the top of the entire growth chamber, in other embodiments, there may be a condensation tower portion accompanying each tier of plants, or still further, the tiers may be implemented by stacking multiple growth chambers 302 on top of each other. As will be discussed in conjunction with FIG. 4A, a single laser light source 312 may illuminate all of the tiers of plants, whether they are located within a single growth chamber 302 or within multiple distinct growth chambers.

Turning now to FIG. 3B, another schematic diagram is illustrated of another example growth chamber 328. As is illustrated in FIG. 3B, scattered light 330 that is conveyed by the diffuser 318 may illuminate the growth chamber 328. In turn, the walls of the chamber may reflect the scattered light 330, and this reflected light 332 may illuminate the lower parts of the plant (e.g., the stem, lower leaf, and shoot) which would otherwise be shaded, thus encouraging better growth and development of the plants or agriculture products located in the growth chamber 328. Further, FIG. 3B illustrates a heating and cooling system 334 designed to regulate the temperature in the interior portion of the growth chamber 328, which is described in greater detail in conjunction with FIG. 3C below.

Turning now to FIG. 3C, a schematic diagram of an example heating and cooling system 334 is illustrated that may be employed in accordance with examples of the present invention. As shown in FIG. 3C, pipes 336 may be installed in the space between the outer and inner walls of a growth chamber. These pipes may be made of materials with a ΔT of 5-8° C. (e.g., Copper or Aluminum), and may be designed to circulate a gas or liquid (e.g., water) to maintain a consistent temperature within the interior portion of the growth chamber.

Turning now to FIG. 3D, a schematic diagram is illustrated of a growth chamber including an example water condensing tower 322. As shown in FIG. 3D, an inner surface of the water condensation tower 322 of the growth chamber may be specially designed to include a plurality of regularly indented cone-shaped structures 338 that encourage condensation of evaporated vapor from soil and/or plants. As the water vapor 320 evaporates from the plants, it rises to the top of the growth chamber, where the water condensation tower 322 is disposed. The water vapor 320 condenses into water droplets 340 in the spaces 342 between the cone-shaped structures comprising the interior walls of the water condensation tower 322, and then the water droplets 340 slide down the interior walls of the growth chamber and back into growth media. In this fashion, the agriculture system enables the recycling of water that would otherwise be lost through evaporation.

In FIG. 4A, a schematic diagram illustrates a laser light source 412 and an example set of optical elements 404 for producing and transmitting laser light 410 to the interior portion 406 of a growth chamber 408. As shown in FIGS. 2 and 3A-3D above, laser light sources may be located externally and apart from a corresponding growth chamber.

Turning now to a description of a laser light source 412, which may comprise laser light sources 212A, 212B, and 312 discussed above, the term “laser” as used herein is an acronym for light amplification by stimulated emission of radiation. The laser light source 412 may thus include any mechanism that generates laser light, including pulsed-laser sources such as Q-switched or mode-locked lasers, or any other laser light sources that can operate in either continuous wave or pulsed conditions. The laser light source 412 may further include any laser derivatives such as supercontinua, or any mechanism that receives light from yet another device, and converts that light into laser light appropriate for use with embodiments disclosed herein. For reasons described previously, the principal purpose of laser light source 412 is to enable the production of light with sufficient coherence that it can be efficiently transmitted into the interior portion 306 of a growth chamber 408.

The laser light sources 412 may produce continuous wave laser light. Examples of continuous wave laser light sources are diode-pumped solid-state lasers, gas lasers, dye lasers, and semiconductor diode lasers. For instance, the laser light source 412 may comprise one or more semiconductor diode lasers arranged in a panel or a bulb. In this regard, the wall plug efficiency of such semiconductor diode lasers can exceed 60% (by comparison, even the most efficient LED light sources have wall-plug efficiencies no higher than 20-30%).

The laser light source 412 may alternatively produce pulsed laser light. Examples of pulsed laser light sources include Q-switched lasers and mode-locked lasers. Continuous wave laser light sources having on-off stages that are modulated by function generators may also produce pulsed laser light, as may continuous wave laser light sources with injection current modulated by a driver circuit.

One primary benefit of using pulsed laser light is that additional gains in efficiency can be produced by tuning the pulse length of the laser light source 412 to match the response time of the photoreceptors in leaves. The laser light source 412 may further be configured so that the pulses occur at intervals equal to or longer than the time taken for plant photoreceptors to be excited (i.e., the time taken for the light to pass through plant cell wall and membrane and into the cytosol and chloroplast where light detecting molecules called photoreceptors response to the light). A pulsed laser light source is thus capable of minimizing photon waste and further boosting the energy efficiency of the agriculture system.

The laser light source 412 can further specifically provide a broad range of coherent single wavelength lights at a controllable dosage (power and time) for energy efficient plant growth. Specific wavelengths of light across a broad spectrum of lights (for example, at 445 nm and 671 nm) can be selected to provide an optimal combination of lights at suitable intensity and ratios for the growth of plants. For instance, some combinations of light wavelengths, as shown in FIG. 4B, produced by the laser light source 412 may include laser light in the ultraviolet region 414. As illustrated in FIG. 4B at 420, when the ultraviolet laser light 414 is emitted with wavelengths below 380 nm and, more favorably, below 300 nm, the illuminating laser light 410 performs a sterilization function, killing many disease-causing microbes within a growth chamber and any liquid growth media contained therein, thus eliminating the need to use chemicals such as pesticides. Alternatively, as illustrated in FIG. 4B at 416, in conjunction with the application of a high voltage (hv), the ultraviolet laser light may excite red, green, and blue phosphor, which in turn generates white light (shown at 418). The white light can be used to illuminate the growth chamber for any practical purpose, such as, for instance, temporary inspection of interior of the chamber or the contents disposed therein.

In some embodiments, the laser light source 412 may include one or more different laser light sources, each of which produces laser light having a specific wavelength. In this manner, depending on the contents of a particular growth chamber, the laser light source 412 may utilize a plurality of different laser light sources to provide illumination by a corresponding number of specific wavelengths of light.

Additionally or alternatively, the wavelengths of the laser light source 412 may be tunable, so that any component laser light source can be tuned to generate laser light at a particular desired frequency (e.g., a laser light source which in some cases may to produce laser light at 445 nm can be tuned to instead produce laser light at 440 nm, which may be a better wavelength for some plant varieties). Similarly, the intensities of the laser light can be modified by modulating the power injected to the laser light source 412, to provide the intensity of light appropriate for the number of tiers that will be illuminated. In these ways, the characteristics of the laser light 410 can be tailored to specifically suit the requirements of different types of plants or different stages of plant growth to achieve the desired growth morphology (e.g., for broad leaves, early flowering etc.).

The optical elements 404 illustrated in FIG. 4A are not necessary in every embodiment (e.g., in some embodiments, laser light source 412 may itself emit laser light 410 that travels into a growth chamber via free space). However, in some embodiments, these optical elements 404 may comprise one or more mirrors and/or any number of other optical elements for guiding the laser light to the growth chamber, such as optical fiber, dichroic mirrors, beam splitters, diffusers, collimators, rotating optical choppers (for slow modulation of light energy), rotating optical choppers with reflector (for sequentially illuminating multiple chamber at time-shifted interval), or any combination thereof. To this end, plastic fiber that has relatively low optical loss can also be used to guide the laser lights into the chamber. In some embodiments, fiber optics and free space transmission can be used in tandem, depending on the specific features of the environment within which the agriculture system is situated. Regardless of the optical elements 404 used to guide the laser light 410, FIG. 4A further illustrates that the laser light 410 produced by laser light source 412 may be split a number of times and directed to a series of growth chambers 408A-408N. Each growth chamber may include a corresponding pairs of collimators and diffusers (402A-402N and 418A-418N, respectively). Each of these collimator-diffuser pairs may provide homogenous illumination of a single tier of plants. Accordingly, embodiments described herein are energy-efficient and can be used to easily scale the production capacity of the system.

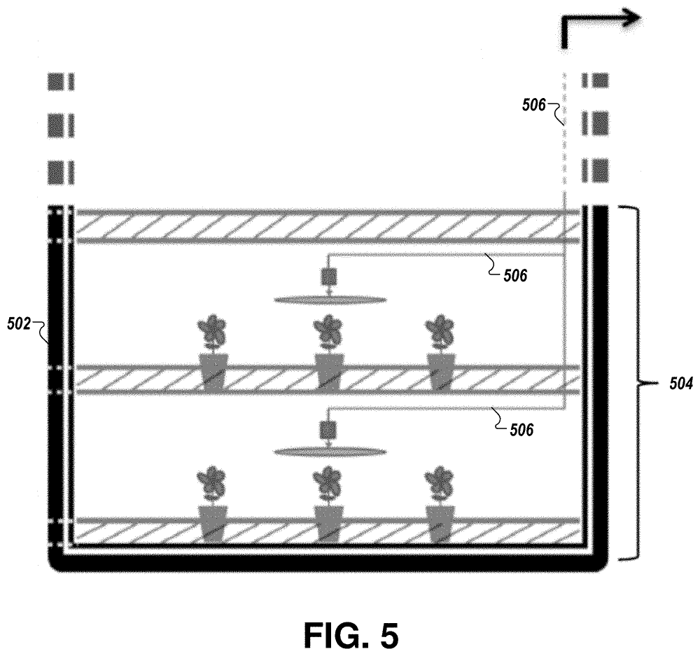

FIG. 5 provides a schematic diagram illustrating a vertical agriculture arrangement of the present invention having multiple tiers of plants. In the example embodiment depicted in FIG. 5, a series of tiers are provided, and this set of tiers 504 may include any number of tiers without departing from the spirit or scope of the present invention. Moreover, a series of optical elements 506 may be used to guide laser light to each of the tiers provided in a growth chamber 502 from an external laser light source connected to the optical elements 506. The arrangement illustrated in FIG. 5 saves energy and cost when compared to traditional vertical agriculture designs, because it provides illumination to multiple tiers of plants without any need to install light panels at the roof of each tier. Additionally, by locating the laser light source outside the growth chamber, heat generated by laser light sources will not be transferred into the growth chamber, whereas in traditional arrangements, heat would transfer from each panel of lights associated with each tier of plants. Accordingly, the embodiment illustrated in FIG. 5 avoids the requirement to constantly cool the growth chamber, which is one of the main issues presented by current technologies using traditional artificial light sources such as fluorescent lights and LEDs.

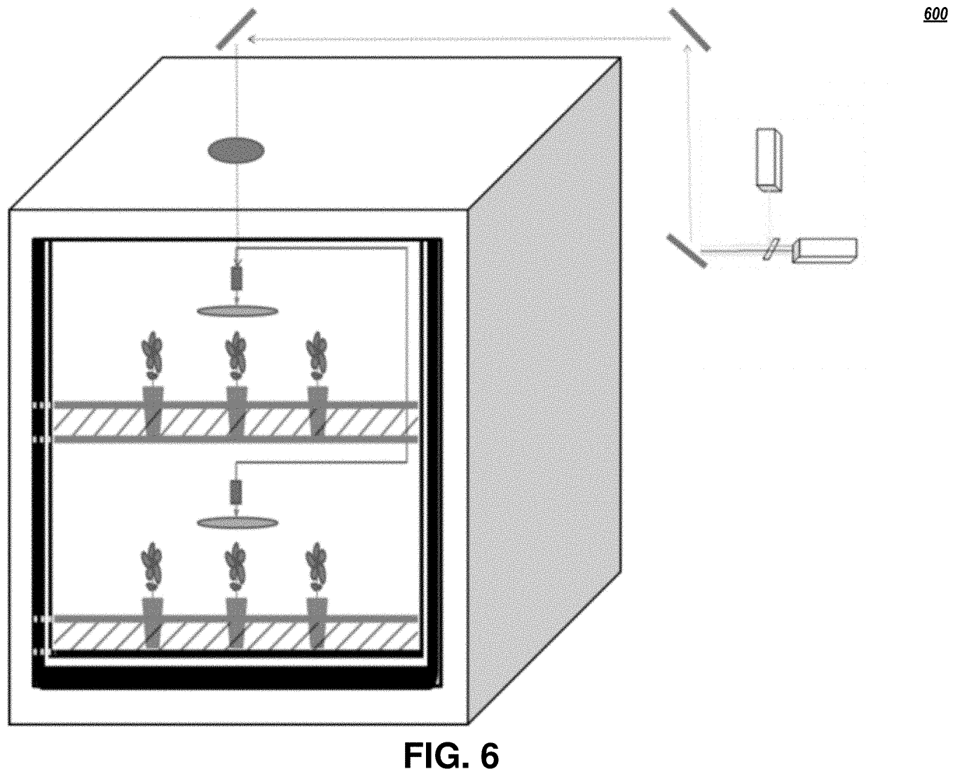

Turning now to FIG. 6, a schematic diagram illustrates an example agriculture system 600 depicting the conjunction of many elements of the above-described embodiments. For instance, in addition to the use of external laser light sources and associated optical elements, as described in association with FIGS. 2-4B above, the agriculture system shown in FIG. 6 further utilizes a vertical agriculture arrangement, as described in connection with FIG. 5. However, it will be understood that any of the features described herein may be utilized in any combination without departing from the spirit or scope of the present invention.

FIG. 7 illustrates a schematic diagram depicting yet another example agriculture system 700, in accordance with examples of the present invention. As illustrated in FIG. 7, the agriculture system 700 may be controlled by a system integrator comprising a computer 702 that may include a processor, a memory, input/output circuitry, and communications circuitry. The processor may include one or more processing devices, and the memory may be a non-transitory electronic storage device (e.g., a computer readable storage medium) comprising one or more volatile and/or non-volatile memories. The memory may be configured to store instructions, that, when executed by the processor, cause the computer 702 to carry out various functions in accordance with example embodiments of the present invention. The input/output circuitry may comprise one or more devices (e.g., a mouse, keyboard, microphone, display, and/or the like) that enable a user to communicate with and/or provide instructions to the computer 702, and the communications circuitry may comprise a network interface that enables the computer 702 to communicate with (and direct operation of) the other elements of the agriculture system 700.

The agriculture system 700 may further include sensing components that monitor, in real-time, the development stages of the plant, water levels, and/or other environmental conditions within the growth chamber. In this regard, the agriculture system 700 may include temperature and humidity sensors 320 (as described previously) and a light intensity sensor 704 disposed within the interior portion of a growth chamber. The agriculture system 700 may further include a heating and cooling system (as described previously), such as water circulation heater/chiller 706, and a feedback controller 708 that operatively controls the laser light source 212. In addition, light/radio frequency (RF) communication sensor(s) 710 may be configured to detect the reflected or transmitted light via light and/or radio frequency (RF) (e.g., Li-Fi and Wi-Fi) based communication sensors 710. This information may then be directed to the system integrator and computer 702 for further processing (e.g., in some embodiments, via a transmission element 712, such as an antenna or other wireless communication instrument, or in other embodiments via a wired connection). In operation, the system integrator and computer 702 may receive signals from the temperature and humidity sensors 320, the light intensity sensor 704, and/or the light/RF communication sensor(s) 710 and may direct operation of the water circulation heater/chiller 706 and the feedback controller 708 (via the communications circuitry) to moderate the temperature, humidity, and light intensity conditions within the interior portion of the growth chamber. Moreover, in some embodiments, where a tunable laser light source is employed, the computer 702 may direct the feedback controller 708 to alter the wavelengths of laser light generated by the laser light source based on the information detected by the light/RF communication sensor(s) 710 and/or a received indication of the type of agriculture products placed within the growth chamber at any given time.

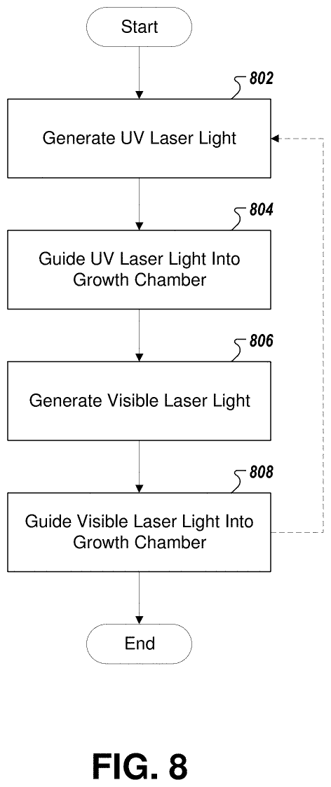

FIG. 8 illustrates a flowchart containing a series of operations performed by embodiments described herein to sterilize a growth chamber 202 and grow agriculture products. In operation 802, the laser light source 212 generates ultraviolet laser light having a wavelength under 380 nm, and more favorably below 300 nm, and most favorably between 220 and 300 nm. In operation 804, this ultraviolet laser light is guided by the optical elements of the agriculture system into the interior portion 206 of the growth chamber 202 to sterilize the growth chamber 202. Because ultraviolet radiation kills any living microorganism, performance of operation 804 renders pesticide use unnecessary. Subsequently, the procedure advances to operation 806.

In operation 806, the laser light source 212 generates visible laser light for growing the plants contained in the growth chamber 202. This visible laser light preferably includes red light having a wavelength of between 440 and 490 nm and blue light having a wavelength of between 650 and 680 nm, although the actual wavelengths selected are advantageously selected to maximize the photosynthetic efficiency of the plants or other agriculture products contained in the growth chamber 202, and accordingly may fall outside these ranges. The optical power of the visible laser is preferably within 80 to 400 μmolm⁻²s⁻¹, although as with the wavelengths light, the optical power may advantageously be tuned to be higher or lower in order to provide an amount of fluent that optimizes the growth of the particular plants or other agriculture products contained within the growth chamber 202. The visible laser light may comprise a continuous wave laser light, or may be pulsed. Plant photoreceptors require time to convert light energy into the energy used for photosynthesis. As a result, using pulses of visible laser light instead of a continuous wave, the agriculture system can save energy by avoiding the illumination of plant photoreceptors during periods where the plants would not utilize the illuminating light. Moreover, utilizing pulsed laser light can reduce the amount of heat generated by the laser light source. As with the choice of wavelengths and optical power of the laser light, the pulsing frequency used by the laser light source 212 may be advantageously selected based on knowledge of the photoreceptor qualities of the plant varieties contained in the growth chamber 202.

Finally, in operation 808, the optical elements guide the visible laser light into the interior portion 206 of the growth chamber 202, where a diffuser scatters the visible laser light to illuminate the plants contained therein. Operations 806 and 808 may continue indefinitely, although the procedure may return to operation 802 to periodically disinfect the growth chamber 202.

Embodiments described herein illustrate an agriculture system designed to illuminate plants in a growth chamber using two wavelengths of light (red and blue). A trial performed utilizing a particular embodiment described herein demonstrates that plants illuminated with only two wavelengths of light (red and blue) can complete a full cycle of growth from germination and up to flowering in similar fashion as plants illuminated by broad spectrum white light. In the trial, Arabidopsis thaliana plants were first allowed to grow under white fluorescent lights for at least two weeks and then exposed to laser lights for seven days under the following conditions. Plants grown only under broad spectrum fluorescent white lights were used as controls. The remaining plants were grown using laser light (90% red (671 nm) and 10% blue (435 nm)). The white fluorescent lamps were installed in the roof of the growth chamber, while the red and blue laser lights were sourced outside the growth chamber, then mixed, guided and diffused into the chamber, in accordance with example embodiments described above. The light sources delivered a fluent of 40-100 μmolm⁻²s⁻¹, and the experiment provided a delivery regime of continuous light for seven days at a temperature of 22° C. and a relative humidity of 50-60%.

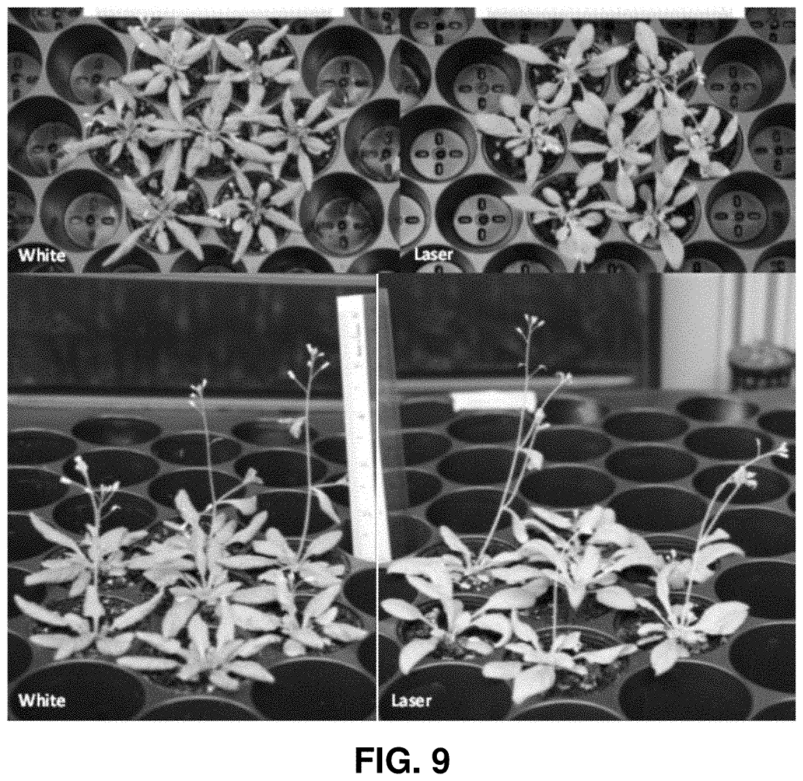

Results of the trial are summarized in Table 1 below and in FIG. 9.

TABLE 1

| | White fluorescent | RB laser |
|---|---|---|
| | lights | lights |
| Leaf morphology^{a} | Sharper ends, | Rounder ends, |
| | more hairs | less hairs |
| | and thicker | and thinner |
| Shade^{a} | Darker green | Brighter green |
| Bolting time^{a} | Later | Earlier |
| Anthocyanin^{a} | Present | Absent |
| Petiole^{a} | Shorter | Longer |
| Fresh weight^{b} (mg) | 550 ± 39.48 | 481.77 ± 17.02 |
| Drg weight^{b} (mg) | 51.60 ± 2.95 | 37.58 ± 1.18 |
| Chlorophyll^{c} (μg/mL/mg) | 4.90 ± 0.21 | 4.21 ± 0.35 |
| Carotenoid^{c} (μg/mL/mg) | 0.54 ± 0.05 | 0.52 ± 0.08 |

Note:
^{a}represents plant phenotypic difference;
^{b}represents physical parameters;
^{c}represents biochemical contents

Table 1 illustrates a comparison of various growth metrics between the control group and the plants grown under RB laser lights. The different plant groups demonstrated phenotypic differences in leaf morphology, shade, bolting time, anthocyanin, and petiole. However, the physical parameters of the plants grown under RB laser lights included only slightly reduced fresh weight, and dry weight. Similarly, while the biochemical content of the plants grown under RB laser lights demonstrated slightly reduced chlorophyll content when compared to the plants grown under white fluorescent light, no meaningful distinction existed in carotenoid content between the groups. Furthermore, FIG. 9 illustrates the visual differences between the plants. As noted in Table 1, the laser-grown plants (on the right side of FIG. 9) demonstrated distinctive phenotypes from those grown under white fluorescent light.

These results suggest that the model plant Arabidopsis thaliana can grow healthily under as few as two monochromatic lights, red and blue, at an optimized ratio of 85% red to 15% blue.

As described above, certain example embodiments of the present invention may reduce the heat generated by the artificial light source illuminating plants in the growth chamber, thus reducing the energy necessary to regulate the temperature of the growth chamber. Similarly, the ability to split laser light to illuminate multiple tiers of plants can significantly reduce the cost and heat impact of a vertical agriculture system, when compared to traditional designs. Furthermore, the very narrow spectrum of light produced by laser light sources avoids the wasted expenditure of energy creating wavelengths of light that are unnecessary for plant growth. In addition, given the exceedingly high wall-plug efficiency of laser light sources, embodiments of the present invention further decrease the energy expense of the system.

Embodiments of the present invention further benefit society more broadly. In the Middle East (and in the Kingdom of Saudi Arabia in particular), farmers can benefit from the water savings and increased crop productivity per land area (enabled by cost-effective vertical agriculture), while also being able to grow crops/fruits/flowers that are usually imported, since indoor agriculture can provide the required temperature, humidity and light parameters for any crops. In turn, consumers are likely to benefit as well, because fresh crops grown locally will carry lower costs due to the reduced cost of transportation. In regions where sunlight is limited, this technology can also provide artificial lighting for agriculture activities throughout the year and independent of the weather. Finally, in regions where physical space is limited, embodiments disclosed above can reduce the cost and increase the efficiency of vertical agriculture.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An agriculture system comprising:
a growth chamber having one or more walls defining an interior portion of the growth chamber;
a tray disposed within the interior portion of the growth chamber, the tray configured to support growth media and one or more agriculture products;
a light source configured to produce pulsed laser light at a pulsing frequency selected based on photoreceptor qualities of the one or more agriculture products and to illuminate at least a part of the interior portion of the growth chamber with pulsed laser light produced by the light source; and
a computer configured to control the light source to select between (1) emitting an ultraviolet light for sterilizing the growth chamber, (2) emitting white light for inspecting an interior of the growth chamber, and (3) emitting the pulsed laser light at the pulsing frequency for growing the one or more agriculture products.

2. The agriculture system of claim 1,
wherein the light source is disposed outside the growth chamber,
wherein at least one of the one or more walls includes at least one aperture configured to communicate the pulsed laser light from outside the growth chamber into the interior portion of the growth chamber, and
wherein the light source is configured to transmit the pulsed laser light into the interior portion of the growth chamber via one or more optical elements and the at least one aperture.

3. The agriculture system of claim 1, further comprising:
a diffuser suspended within the interior portion of the growth chamber and configured to scatter pulsed laser light; and
a collimator disposed within the growth chamber and configured to convey pulsed laser light to the diffuser.

4. The agriculture system of claim 1, further comprising:
one or more additional trays disposed within the interior portion of the growth chamber; and
one or more optical elements configured to direct pulsed laser light received from the light source towards the tray and the one or more additional trays.

5. The agriculture system of claim 1, further comprising:
the computer configured to control wavelengths and intensity of pulsed laser light from the light source.

6. The agriculture system of claim 1, wherein the light source comprises at least one of: a Q-switched laser, a mode-locked laser, a continuous wave laser light source with an on-off stage modulated by a function generator, or a continuous wave laser light source with an injection current modulated by a driver circuit.

7. The agriculture system of claim 1, wherein the light source comprises a tunable laser light source.

8. The agriculture system of claim 1, wherein the light source comprises one or more semiconductor diode lasers arranged in a panel or a bulb.

9. The agriculture system of claim 1, wherein the light source is configured to emit pulsed laser light at one or more predetermined wavelengths, and wherein the one or more predetermined wavelengths include:
a wavelength within the range of 440 nm to 490 nm;
a wavelength within the range of 650 nm to 680 nm
a wavelength less than or equal to 380 nm;
a wavelength less than or equal to 300 nm;
a wavelength less than or equal to 300 nm; or
a wavelength between 220 nm and 300 nm.

10. The agriculture system of claim 1, wherein the light source is configured to generate pulsed laser light with a fluent within the range of 80 μmolm⁻²s⁻¹ to 400 μmolm⁻²s⁻¹.

11. The agriculture system of claim 1, wherein an inner wall lining of at least one wall of the growth chamber comprises:
at least one reflective material selected from the group consisting of SiO₂, Si₃N₄, aluminum, or chrome plating;
at least one metallic material;
at least one dielectric material; or
a combination thereof.

12. The agriculture system of claim 1, wherein an upper portion of the growth chamber comprises a water condensation tower.

13. The agriculture system of claim 1, further comprising:
a heating and cooling system configured to regulate temperature within the growth chamber.

14. The agriculture system of claim 1, further comprising:
a humidifier configured to regulate humidity within the growth chamber.

15. The agriculture system of claim 1, wherein the light source is configured to select a pulsing frequency of the pulsed laser light such that pulses occur at intervals equal to or longer than a time taken for plant photoreceptors to be excited.

16. An agriculture system comprising:
a growth chamber having one or more walls defining an interior portion of the growth chamber, at least one of the one or more walls including at least one aperture configured to communicate artificial light from outside the growth chamber into the interior portion of the growth chamber;
an artificial light source disposed outside the growth chamber and configured to produce pulsed laser light and to illuminate at least a part of the interior portion of the growth chamber with pulsed laser light produced by the light source at a pulsing frequency selected based on photoreceptor qualities of the one or more agriculture products;
one or more optical elements configured to communicate artificial light from the artificial light source, via the at least one aperture, into the interior portion of the growth chamber; and
a computer configured to control the artificial light source to select between (1) emitting an ultraviolet light for sterilizing the growth chamber, (2) emitting white light for inspecting an interior of the growth chamber, and (3) emitting the pulsed laser light at the pulsing frequency for growing the one or more agriculture products.

17. A method for growing agriculture products in a growth chamber that has at least one aperture configured to communicate laser light from outside the growth chamber to an interior portion of the growth chamber, the method comprising:
generating, by a laser light source disposed outside the growth chamber, pulsed laser light at a pulsing frequency selected based on photoreceptor qualities of the one or more agriculture products;
guiding the pulsed laser light through the at least one aperture to illuminate the interior portion of the growth chamber;
controlling the light source to select between (1) emitting an ultraviolet light for sterilizing the growth chamber, (2) emitting white light for inspecting an interior of the growth chamber, and (3) emitting the pulsed laser light at the pulsing frequency for growing the one or more agriculture products.

18. The method of claim 17, further comprising:
guiding the ultraviolet laser light through the at least one aperture to sterilize the interior portion of the growth chamber.
